(19) United States
(12) Patent Application Publication
(10) Pub. No.: US 2011/0260966 A1
(43) Pub. Date: Oct. 27, 2011

(54) Fingerprint reader device and electronic apparatus

(75) Inventor: Takeshi Okazaki, Kawasaki (JP)

(73) Assignee: FUJITSU LIMITED, Kawasaki (JP)

(21) Appl. No.: 13/067,884

(22) Filed: Jul. 1, 2011

Related U.S. Application Data
(63) Continuation of application No. PCT/JP2009/051354, filed on Jan. 28, 2009.

(51) Int. Cl. G09G 5/00

(52) U.S. Cl. 345/156

(57) ABSTRACT

The present invention relates to a slide-type fingerprint reader device in which a finger is slid on the fingerprint sensor, and a positioning structure that causes a first joint portion of a finger to be positioned at the center point of the fingerprint sensor includes a sensor movement mechanism, which keeps the fingerprint sensor at a position bulging from a slide surface on which the finger is slid when the fingerprint sensor is not pressed down, and which allows the fingerprint sensor to move upon being pressed down.

### TECHNICAL FIELD

The present invention relates to a fingerprint reader device and an electronic apparatus.

### BACKGROUND ART

In recent years, fingerprint reader devices with a slide-type or sweep-type (hereinafter referred to as a slide-type) fingerprint sensor that can be implemented as a small-size device at low cost have started to become widely used in the field of information processing apparatuses such as PCs (personal computers), PDA (Personal Digital Assistants), and portable phones.

FIGS. 1A through 1C are drawings for illustrating a fingerprint scan range and a scan method of such a slide-type fingerprint reader device. In a slide-type fingerprint reader device, a portion of a finger F from a first joint J1 to its tip (i.e., the portion indicated by an arrow L) is used as a scan range. The finger may thus need to be placed properly on a scan surface such that the first joint portion J1 of the scanned finger F is placed at around the center of a fingerprint sensor 1 (see FIG. 1B and FIG. 1C).

A fingerprint FP can be reliably scanned when the finger F is slid in a direction of an arrow X such that the center of the finger F passes through the center point O of the fingerprint sensor 1 as illustrated in FIG. 2A. However, the fingerprint sensor 1 is obscured behind the finger F at the time of fingerprint scanning. It may thus be difficult to place the first joint J1 properly on the fingerprint sensor 1.

One may fail to properly position the first joint J1 at the center point O of the fingerprint sensor 1. For example, the position of the first joint J1 may deviate to the left or right relative to the center point O of the fingerprint sensor 1 as illustrated in FIG. 2B, or the position of the first joint J1 may be placed below the center point O of the fingerprint sensor 1 as illustrated in FIG. 2C. In such cases, part of the image that needs to be scanned may be missing, resulting in an insufficient image and thus authentication failure.

In order to solve such a problem, a method of placing a finger may comprise aligning the first joint of the finger with the center point of the fingerprint sensor by keeping visual contact with the fingerprint sensor and its surrounding position from an angle slightly off to the left or right from the position immediately above the fingerprint sensor such as to avoid obscuring the fingerprint sensor with the finger. The problem with this method, however, is that one is forced to take a cramped position each time the fingerprint scan is performed.

As a method for solving the above-noted problems, Patent Document 1 discloses the structure in which a pair of ridges arranged substantially in parallel to each other is provided as guide members, and the ridges serving as the guide members extend in the direction in which a finger is slid. Further disclosed is the provision of a roller and two projecting guide members immediately behind a transparent member for scanning a fingerprint, the projecting guide members spaced at an interval slightly shorter than the finger width and extending in the direction in. which a finger is slid (front to rear).

Patent Document 2 discloses the configuration in which a switch is provided at a short distance from the fingerprint sensor anteriorly in the fingerprint slide direction to detect the presence or absence of a finger F of a subject. This switch is configured to be pressed down by the ball of the finger distal to the first joint.

Further, Patent Document 3 discloses a pair of case pads provided on both sides of a V-letter-shape groove such that these case pads serve as indicators for the position of a finger at the time of fingerprint detection. When a fingerprint is to be detected by a sweep-type fingerprint sensor, the finger is placed such that the first joint closest to the finger tip is situated on the straight line connecting between the two case pads.

[Patent Document 1] Japanese Laid-open Patent Publication No. 2004-240924

[Patent Document 2] Japanese Laid-open Patent Publication No. 2004-272745

[Patent Document 3] Japanese Laid-open Patent Publication No. 2005-259150

### DISCLOSURE OF INVENTION

### Problem to be Solved by Invention

In the method disclosed in above-noted Patent Document 1, the ball of a finger is placed evenly in contact with the two projecting guide members spaced at an interval slightly shorter than the finger width. With this arrangement, it may be possible to guide the initial position of the finger to the center position in the direction perpendicular to the finger slide direction on the fingerprint sensor. However, the first joint of the finger may fail to be placed around the center point of the fingerprint sensor in the finger slide direction on the fingerprint sensor.

In the method disclosed in Patent Document 2, the switch is pressed down by the ball of a finger distal to the first joint. It is not guaranteed, however, that the center of the ball of the finger can press the switch by relying on a view of the dorsal side of the finger. This may result in an insufficient fingerprint image, creating a risk of having an authentication failure.

In the method disclosed in Patent Document 3, it is not easy to ascertain the position of the first joint by relying on a view of the dorsal side of the finger. This may result in an insufficient fingerprint image, creating a risk of failing to perform reliable authentication.

### MEANS TO SOLVE THE PROBLEM

It is a general object of the present invention to provide an improved, useful fingerprint reader device and electronic apparatus that obviate the above-described problems of the related art.

It is a further detailed object of the present invention to provide a fingerprint reader device and an electronic device that can ensure finger placement at a proper scan position without forcing a cramped position, thereby being able to perform accurate fingerprint authentication.

The above-noted object may be achieved by a fingerprint reader device or an electronic apparatus using such a device, wherein the fingerprint reader device includes a slide-type fingerprint sensor and a positioning structure that causes a first joint portion of a finger to be positioned at a center point of the fingerprint sensor, wherein the positioning structure includes a sensor movement mechanism that keeps the fingerprint sensor at a position bulging from a slide surface on which the finger is slid when the fingerprint sensor is not pressed down, and that causes the fingerprint sensor to move to the slide surface upon being pressed down.

### ADVANTAGE OF THE INVENTION

The above-noted fingerprint reader device ensures the correct positioning of a finger at a proper position relative to the fingerprint sensor, thereby improving authentication accuracy.

### BRIEF DESCRIPTION OF DRAWINGS

FIG. 1A is a drawing for illustrating a fingerprint scan range.

FIG. 1B is a drawing for illustrating a method of sliding a finger at the time of scanning a fingerprint (part 1).

FIG. 1C is a drawing for illustrating a method of sliding a finger at the time of scanning a fingerprint (part 2).

FIG. 2A is a drawing for illustrating the position of a fingerprint sensor and the way a finger is placed (in a proper arrangement).

FIG. 2B is a drawing for illustrating the position of a fingerprint sensor and the way a finger is placed (in an improper arrangement: part 1).

FIG. 2C is a drawing for illustrating the position of a fingerprint sensor and the way a finger is placed (in an improper arrangement: part 2).

FIG. 3 is an oblique perspective view illustrating a personal computer provided with a fingerprint reader device of a first embodiment.

FIG. 4 is a drawing illustrating an enlarged view of a portion indicated by an arrow X in FIG. 3 during a fingerprint scan.

FIG. 5 is a drawing illustrating an enlarged view of a portion indicated by an arrow X in FIG. 3 after a fingerprint scan.

FIG. 6 is a plan view illustrating the fingerprint reader device according to the first embodiment of the present invention.

FIG. 7 is a cross-sectional view illustrating the fingerprint reader device according to the first embodiment of the present invention before a finger is slid.

FIG. 8 is a cross-sectional view illustrating the fingerprint reader device according to the first embodiment of the present invention during a finger slide (part 1).

FIG. 9 is a cross-sectional view illustrating the fingerprint reader device according to the first embodiment of the present invention during a finger slide (part 2).

FIG. 10 is a plan view illustrating the fingerprint reader device according to the second embodiment of the present invention.

FIG. 11 is a cross-sectional view illustrating the fingerprint reader device according to the second embodiment of the present invention before a finger is slid.

FIG. 12 is a cross-sectional view illustrating the fingerprint reader device according to the second embodiment of the present invention during a finger slide (part 1).

FIG. 13 is a cross-sectional view illustrating the fingerprint reader device according to the second embodiment of the present invention during a finger slide (part 2).

FIG. 14 is a plan view illustrating the fingerprint reader device according to the third embodiment of the present invention.

FIG. 15 is a cross-sectional view illustrating the fingerprint reader device according to the third embodiment of the present invention before a finger is slid.

FIG. 16 is a cross-sectional view illustrating the fingerprint reader device according to the third embodiment of the present invention during a finger slide (part 1).

FIG. 17 is a cross-sectional view illustrating the fingerprint reader device according to the third embodiment of the present invention during a finger slide (part 2).

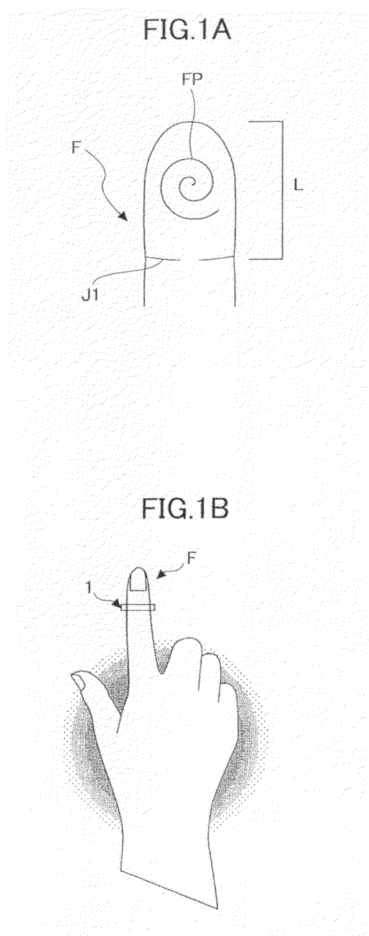

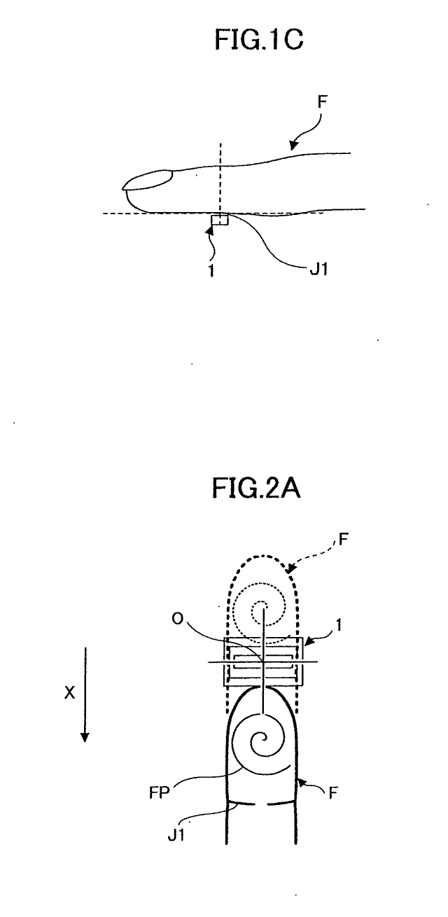

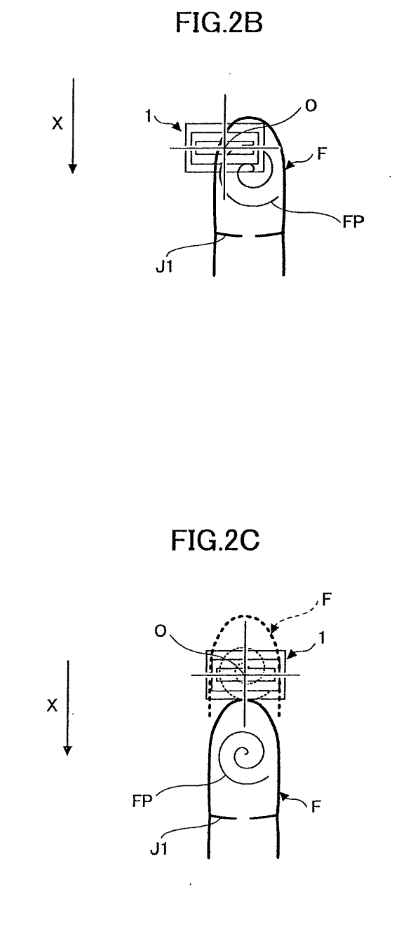

### DESCRIPTION OF REFERENCE SYMBOLS

1 fingerprint sensor

2 front-side finger-slide surface

3 rear-side finger-slide surface

4, 5 guide sidewall

7 to 9 spring

32 movable front-side finger-slide surface

33 movable rear-side finger-slide surface

110A to 110C fingerprint reader device

F finger

FP fingerprint

J1 first joint

### BEST MODE FOR CARRYING OUT THE INVENTION

In the following, embodiments of the present invention will be described with reference to the accompanying drawings.

### First Embodiment

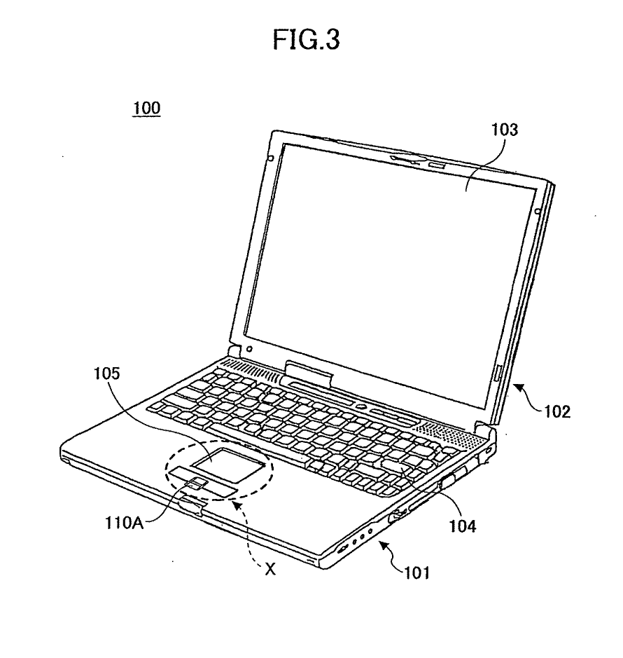

FIG. 3 through FIG. 5 illustrate an example in which a fingerprint reader device 110A is implemented as a first embodiment of the present invention. The present embodiment is directed to an example in which the fingerprint reader device 110A is incorporated into a personal computer 100 that is an example of an electronic apparatus. As illustrated in FIG. 3, the personal computer 100 includes a core part 101 having a keyboard 104, a flat point 105, and so on and a cover part 102 provided with a liquid crystal display 103 and so on.

The fingerprint reader device 110A is situated near the flat point 105. The fingerprint reader device 110A is a device for scanning a fingerprint FP of a finger F. The personal computer 100 has such hardware as a processing unit such as a CPU and a memory unit for storing programs and data. The processing unit of the personal computer 100 compares the fingerprint FP scanned by the fingerprint reader device 110A with the data stored in the memory unit in advance by use of a program stored in the memory unit. The processing unit controls whether to allow the use of the personal computer 100 in response to the result of the comparison. With this arrangement, only a person who has registered a fingerprint in advance can use the personal computer 100, which can improve security.

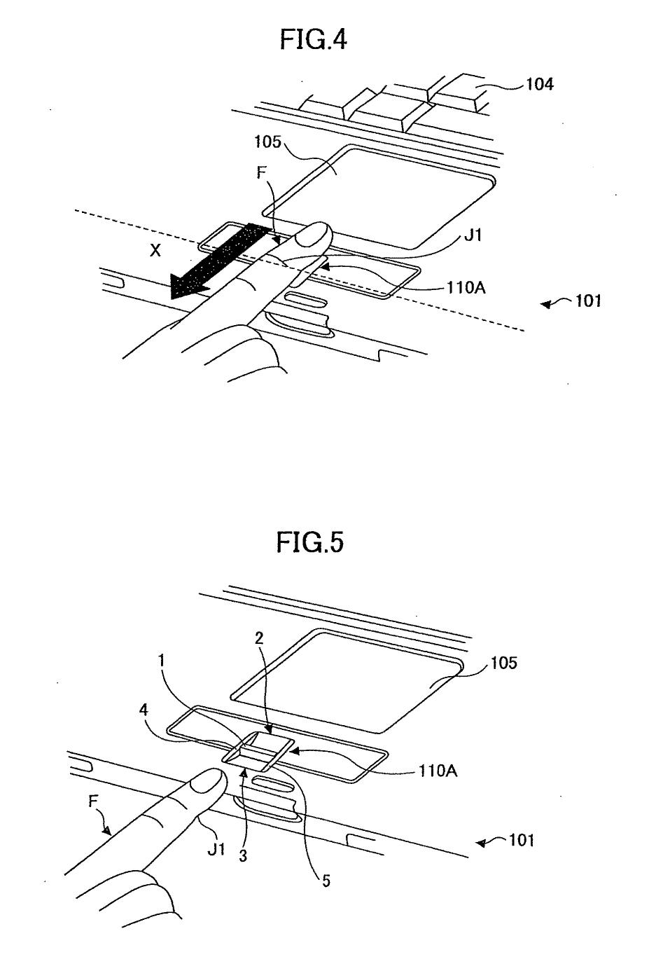

The fingerprint reader device 110A of the present embodiment is a slide-type fingerprint reader device that scans the fingerprint FP of the finger F being slid on the fingerprint sensor 1. Specifically, the finger F is placed on the fingerprint reader device 110A and slid in the direction of an arrow X to have the fingerprint scanned, as illustrated in FIG. 4. As was previously described, the finger F may need to be slid after the first joint portion J1 of the finger F to be slid is positioned at the center point O of the fingerprint sensor 1. FIG. 5 illustrates the end of scan.

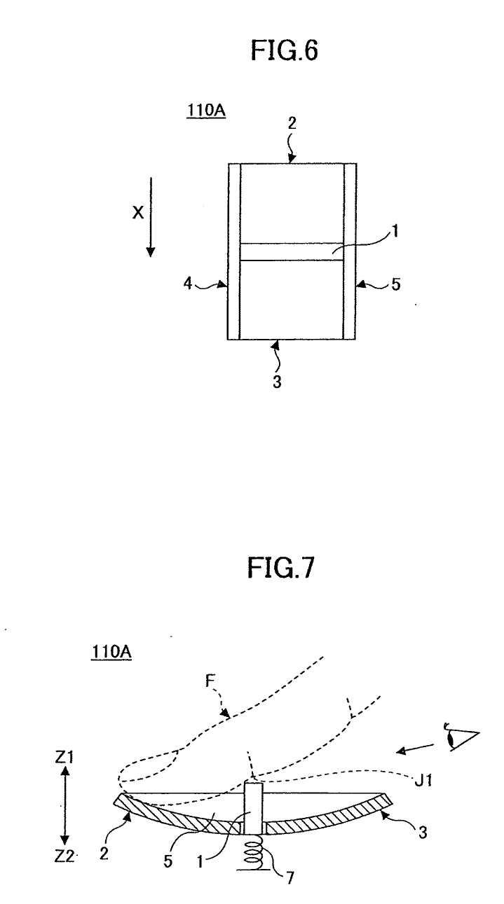

As illustrated in FIG. 5 and FIG. 6, the fingerprint reader device 110A of the first embodiment includes a fingerprint sensor 1, a front-side finger-slide surface 2, a rear-side finger-slide surface 3, a guide sidewall 4, and a guide sidewall 5, and so on.

The front-side finger-slide surface 2 and the rear-side finger-slide surface 3 constitute a slide surface on which the finger F is slid at the time of scanning the fingerprint FP. The front-side finger-slide surface 2 is situated on the front side of the fingerprint sensor 1 in the finger-F slide direction (i.e., the direction of the arrow X). The rear-side finger-slide surface 3 is situated on the rear side of the fingerprint sensor 1 in the finger-F slide direction (i.e., the direction of the arrow X).

The guide sidewalls 4 and 5 are situated on both sides of the front-side finger-slide surface 2 and the rear-side finger-slide surface 3 constituting the surfaces on which the finger F is slid. The upper faces of the guide sidewalls 4 and 5 are set at such elevation as to be flush with the surface of the core part 101.

In contrast, the front-side finger-slide surface 2 and the rear-side finger-slide surface 3 have curved shape that bulges downwards when a cross-sectional view is taken, in order to ensure smooth sliding movement of the finger F (see FIG. 7). Accordingly, the elevation of the front-side finger-slide surface 2 and the rear-side finger-slide surface 3 are relatively low, compared with the elevation of the upper faces of the guide sidewalls and 5. With this arrangement, the sides of the finger F are guided by the guide sidewalls 4 and 5 when the finger F is slid over the surfaces (i.e., the front-side finger-slide surface 2 and the rear-side finger-slide surface 3), thereby ensuring smooth finger slide movement.

In the following, a description will be given of the arrangement of the fingerprint sensor 1 in the fingerprint reader device 110A according to the present embodiment by referring to FIG. 6 and FIG. 7. The fingerprint reader device 110A of the present embodiment is configured such that the fingerprint sensor 1 is movable in the vertical direction (i.e., directions Z1 and Z2) relative to the surface on which the finger F is slid.

An elastic means to function as a movement mechanism for moving the fingerprint sensor 1 is provided at the bottom of the fingerprint sensor 1 (i.e., the backside of the finger-slide surfaces 2 and 3). This elastic means provides upward elastic urge for the fingerprint sensor 1 (in the direction of the arrow Z1 in the figure). The fingerprint sensor 1 moves toward the slide surface (in the direction of the arrow Z2) upon being pressed. The elastic means may be a spring, plastic, rubber, etc., and may be used in combination with a link mechanism or the like. The present embodiment illustrates an example in which only a coil-shape spring 7 is used for the purpose of simplifying the structure.

In the configuration noted above, the fingerprint sensor 1 is shifted against the elastic force of the spring 7 in the direction Z2 in the figure upon being pressed. When this happens, the tip of the fingerprint sensor 1 is pressed down to the same elevation as the slide surface on which the finger F is slid.

Upon being released from the pressing, the fingerprint sensor 1 moves in the direction Z1 by the elastic restoration force of the spring 7 to return to its original position. When there is no pressing, the tip of the fingerprint sensor 1 is arranged to slightly bulge relative to the upper faces of the guide sidewalls 4 and 5 (see FIG. 7).

The bulge of the tip of the fingerprint sensor 1 from the upper faces of the guide sidewalls 4 and 5 as described above allows the position of the fingerprint sensor 1 to be checked on the near side of a lowered stretched finger when the finger F is lowered toward the fingerprint reader device 110A. The first joint J1 can thus be properly positioned relative to the fingerprint sensor 1.

Further, the sense of touch provided by the finger F is also utilized in addition to visual contact. The finger F is lowered toward the fingerprint reader device 110A such that the ball of the finger F is evenly in contact with the paired guides 4 and 5. The finger F then comes in contact with the fingerprint sensor 1 as illustrated in FIG. 7. At this time, care is taken such that the ball of the finger F does not touch the fingerprint sensor. Through the sense of touch provided by the finger F at this time, the position of the finger F relative to the fingerprint sensor 1 can be recognized by the feel of the finger F.

As the finger F is lowered towards the fingerprint reader device 110A, the finger F comes in contact with the fingerprint sensor 1 as illustrated in FIG. 7. Through the sense of touch provided by the finger F at this time, the position of the finger F relative to the fingerprint sensor 1 can be recognized by the feel of the finger F.

Accordingly, in 110A according to the present embodiment, the positional displacement of the first joint J1 of the finger F relative to the fingerprint sensor 1 can be directly recognized. With this arrangement, it is possible to adjust the position of the first joint J1 to place it at the center point O of the fingerprint sensor 1 even when the fingerprint sensor 1 is obscured behind the finger F. Namely, the movement mechanism (i.e., spring 7) and the fingerprint sensor 1 serve as a positioning device for positioning the first joint J1 of the finger F at the center point O of the fingerprint sensor 1.

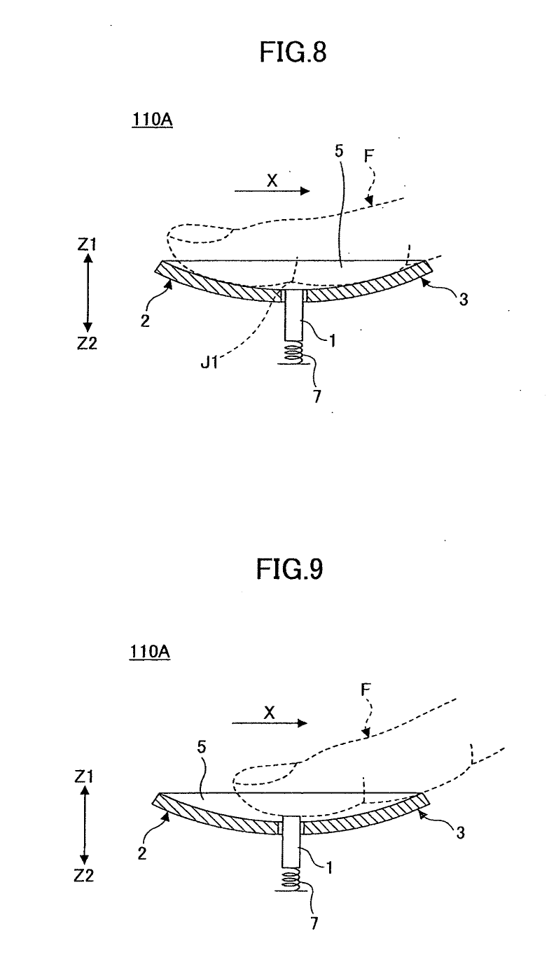

Upon confirming the correct position of the finger F as described above, the first joint J1 is pressed against the fingerprint sensor 1 as illustrated in FIG. 8. As a result, the fingerprint sensor 1 is pressed down to the same elevation as the slide surface (which is constituted by the front-side finger-slide surface 2 and the rear-side finger-slide surface 3).

Subsequently, the finger is slid at constant speed in the direction of the arrow X in the figure while pressing down the fingerprint sensor 1 with the ball of the finger F distal to the first joint J1 as illustrated in FIG. 9, thereby performing correct scanning of the fingerprint FP. In so doing, the fingerprint sensor 1 has been moved to the slide surface as described above, thereby not obstructing the sliding movement of the finger F.

In the fingerprint reader device 110A of the present embodiment, further, the fingerprint sensor 1 is urged upward (in the direction Z1) all the time by the spring 7. Because of this, the fingerprint sensor 1 is constantly pressed against the finger F by the elastic force of the spring 7 while the finger F slides over the fingerprint sensor 1.

In the case of a thin finger or tapering finger (many people have a tapering index finger) or in the case of a child or elderly person having an insufficient strength to press a finger to the sensor, the pressing of the finger against the sensor may become insufficient in the second half of a finger slide even when the first joint J1 of the finger F is correctly placed at the center position O of the fingerprint sensor 1. In such a case, an upper part of the image of the fingerprint FP may become missing or insufficient, thereby likely resulting in authentication failure.

In the present embodiment, however, the fingerprint sensor 1 is constantly urged upward by the spring 7 as described above, so that the fingerprint sensor 1 is constantly pressed against the finger F that is being slid. Accordingly, a correct image can be obtained even in the case of scanning the fingerprint FP of a thin finger or tapering finger or in the case of scanning the fingerprint FP for a child or an elderly person. This can further improve the authentication rate.

The present embodiment has illustrated a mode of operation in which the fingerprint sensor 1 is confirmed on the near side of the stretched finger being lowered when the first joint J1 is to come in contact with the fingerprint sensor 1. Notwithstanding this, another mode of operation may be used in which the finger is slid over the rear-side finger-slide surface 3 in the direction opposite the finger slide direction while stretching the finger F. In this mode of operation, the user brings the first joint J1 in contact with the fingerprint sensor 1 bulging from the rear-side finger-slide surface 3 (and avoids touching the fingerprint sensor 1 with the ball of the finger F) while causing the ball of the finger F to be evenly in contact with the guide sidewalls 4 and 5 by utilizing visual contact and the feel of the finger F. The user performs positional adjustment to move the finger F to a correct position, followed by pressing the fingerprint sensor 1 with the first joint J1. With this arrangement, a similar advantage to what was previously described is obtained.

### Second Embodiment

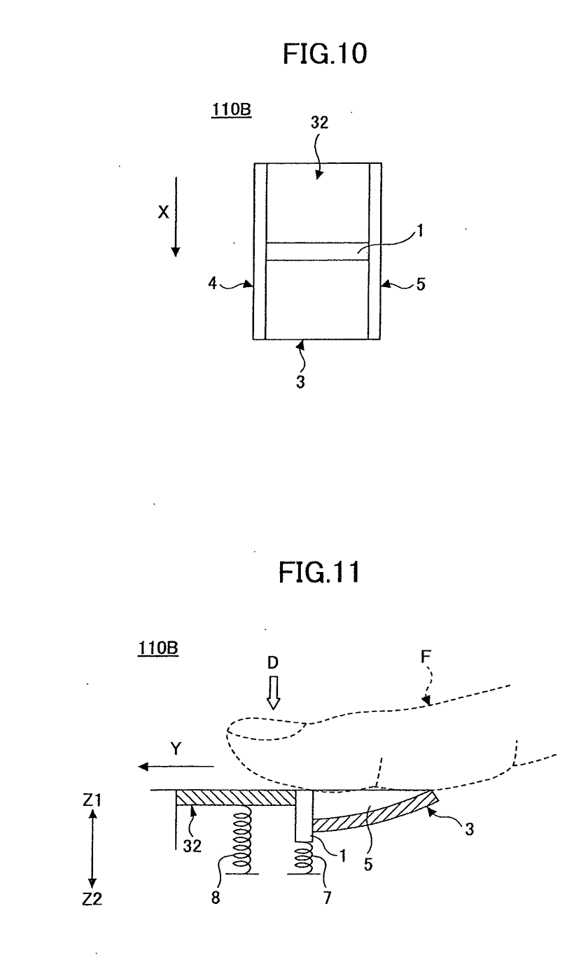

FIG. 10 through FIG. 13 illustrate a fingerprint reader device 110B according to a second embodiment. In the fingerprint reader device 110A of the first embodiment described above, only the fingerprint sensor 1 is configured to move vertically (i.e., move in the directions Z1 and Z2) relative to the surface (constituted by the front-side finger-slide surface 2 and the rear-side finger-slide surface 3) on which the finger F is slid.

On the other hand, the fingerprint reader device 110B of the present embodiment is configured such that a movable front-side finger-slide surface 32 in addition to the fingerprint sensor 1 moves vertically (hereinafter the front-side finger-slide surface 2 of the present embodiment will be referred to as the movable front-side finger-slide surface 32).

At the bottom of the movable front-side finger-slide surface 32, an elastic means is provided to serve as a finger-slide surface movement mechanism for moving the movable front-side finger-slide surface 32. This elastic means provides upward elastic urge for the movable front-side finger-slide surface 32 (in the direction of the arrow Z1 in the figure). The movable front-side finger-slide surface 32 moves (in the direction of the arrow Z2) toward the same elevation as the rear-side finger-slide surface 3 upon being pressed.

The elastic means may be a spring, plastic, rubber, etc., and may be used in combination with a link mechanism or the like. The present embodiment illustrates an example in which only a coil-shape spring 8 is used for the purpose of simplifying the structure.

Provision is made such that the tip of the fingerprint sensor 1 and the surface of the movable front-side finger-slide surface 32 can be pressed down to the same elevation as the rear-side finger-slide surface 3. Namely, the fingerprint sensor 1 and the movable front-side finger-slide surface 32 are in such a state as to bulge relative to the rear-side finger-slide surface 3 when a finger slide is not performed. The fingerprint sensor 1 and the sensor movement mechanism for moving the fingerprint sensor 1 have the same configuration that moves the fingerprint sensor 1 in the seventh embodiment, and a description thereof will be omitted.

In the configuration noted above, the fingerprint sensor 1 and the movable front-side finger-slide surface 32 are shifted against the elastic force of the springs 7 and 8 in the direction Z2 in the figure upon being pressed. Upon being released from the pressing, the fingerprint sensor 1 and the movable front-side finger-slide surface 32 move in the direction Z1 by the elastic restoration force of the springs 7 and 8 to return to their original position (bulging position).

In order to scan the fingerprint FP by use of the fingerprint reader device 110B having the configuration described above, the finger F is slid as illustrated in FIG. 11 over the rear-side finger-slide surface 3 in the direction (as illustrated by an arrow Y in FIG. 11) opposite the finger slide direction while stretching the finger F. In so doing, the sense of touch provided by the finger F is also utilized in addition to visual contact. The first joint J1 of the finger F is then brought in contact with the fingerprint sensor 1 bulging from the rear-side finger-slide surface 3 while ensuring that the ball of the finger F is evenly in contact with the paired guide sidewalls 4 and 5. At this point in time, care is taken to keep the ball of the finger F from touching the fingerprint sensor 1.

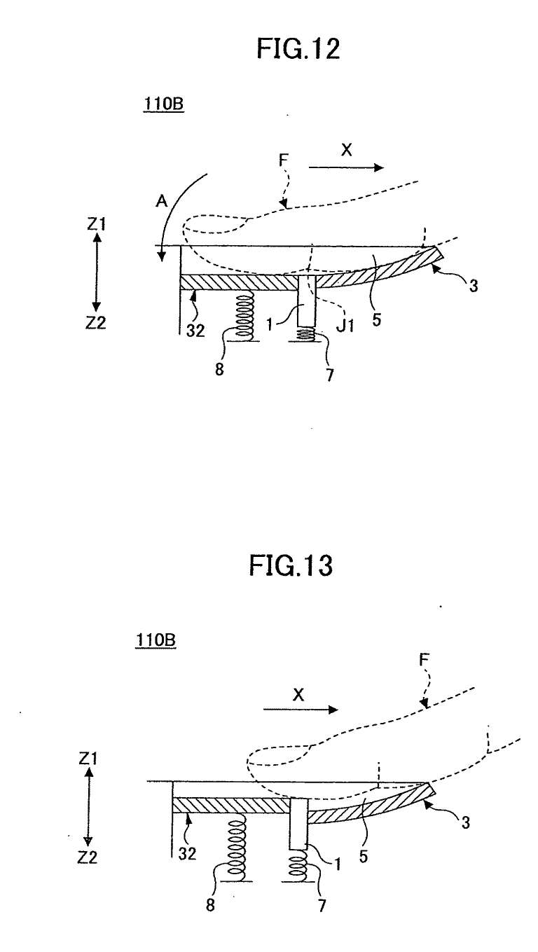

After performing positional adjustment to move the finger F to the correct position, the stretched finger F is tilted to press down the fingerprint sensor 1 and the movable front-side finger-slide surface 32 (i.e., pressing them down in the direction indicated by an arrow A in FIG. 12). As a result, the fingerprint sensor 1 and the movable front-side finger-slide surface 32 are pressed down to the same elevation as the rear-side finger-slide surface 3 as illustrated in FIG. 12.

In this manner, the first joint J1 can be placed at the center point O of the fingerprint sensor 1. After this, the finger F is slid at constant speed in the direction of the arrow X while pressing down the fingerprint sensor 1 with the ball of the finger F as illustrated in FIG. 13, thereby performing correct scanning of the fingerprint FP. In so doing, the fingerprint sensor 1, the movable front-side finger-slide surface 32, and the rear-side finger-slide surface 3 form a single continuous surface, so that the fingerprint sensor 1 and the movable front-side finger-slide surface 32 do not obstruct the sliding movement of the finger F.

With this arrangement, it is possible to adjust the position of the first joint J1 to place it at the center point O of the fingerprint sensor 1 even when the fingerprint sensor 1 is obscured behind the finger F. Namely, the finger-slide-surface movement mechanism (i.e., spring 8) and the movable front-side finger-slide surface 32 as well as the sensor movement mechanism (i.e., spring 7) and the fingerprint sensor 1 serve as a positioning device for positioning the first joint J1 of the finger F at the center point O of the fingerprint sensor 1.

In the present embodiment also, the fingerprint sensor 1 is constantly pressed against the finger F being slid, similarly to that of the seventh embodiment previously described. Accordingly, a correct image can be obtained even in the case of scanning the fingerprint FP of a thin finger or tapering finger or in the case of scanning the fingerprint FP for a child or an elderly person. This can further improve the authentication rate.

The above-described embodiment has been directed to an example in which the fingerprint sensor 1 and the movable front-side finger-slide surface 32 move independently of each other. Alternatively, the fingerprint sensor 1 and the movable front-side finger-slide surface 32 may be integrated so as to move together with each other.

### Third Embodiment

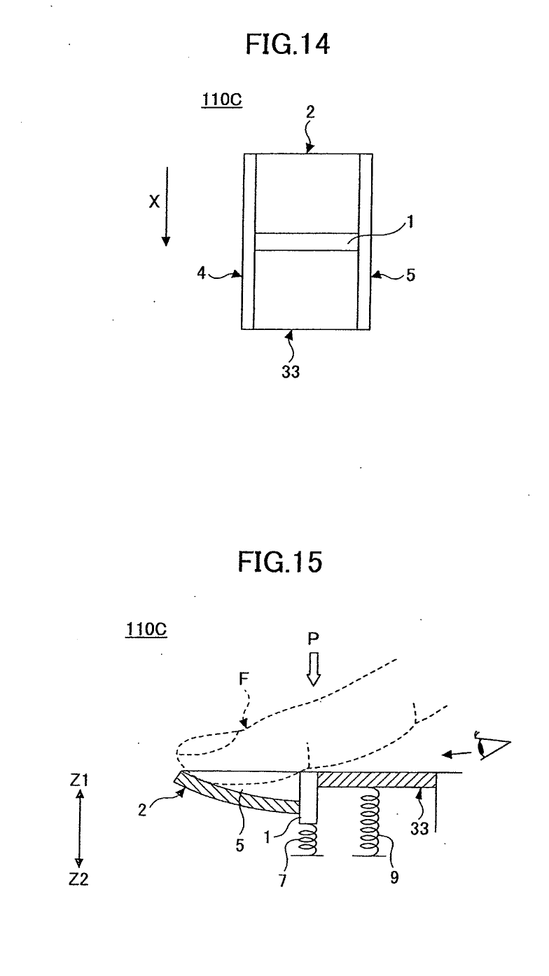

FIG. 14 through FIG. 17 illustrate a fingerprint reader device 110C according to a third embodiment. In the fingerprint reader device 110B of the second embodiment described above, only the fingerprint sensor 1 and the movable front-side finger-slide surface 32 are configured to move vertically (i.e., move in the directions Z1 and Z2) relative to the surface (constituted by the front-side finger-slide surface 2 and the rear-side finger-slide surface 3) on which the finger F is slid.

On the other hand, the fingerprint reader device 110C of the present embodiment is configured such that a movable rear-side finger-slide surface 3 in addition to the fingerprint sensor 1 moves vertically relative to the slide surface (hereinafter the rear-side finger-slide surface 3 of the present embodiment will be referred to as a movable rear-side finger-slide surface 33).

At the bottom of the movable rear-side finger-slide surface 33, an elastic means is provided to serve as a finger-slide surface movement mechanism for moving the movable rear-side finger-slide surface 33. This elastic means provides upward elastic urge for the movable rear-side finger-slide surface 33 (in the direction of the arrow Z1 in the figure). The movable rear-side finger-slide surface 33 moves toward the front-side finger-slide surface 2 (in the direction of the arrow Z2) upon being pressed.

The elastic means may be a spring, plastic, rubber, etc., and may be used in combination with a link mechanism or the like. The present embodiment illustrates an example in which only a coil-shape spring 9 is used for the purpose of simplifying the structure.

Provision is made such that the tip of the fingerprint sensor 1 and the surface of the movable rear-side finger-slide surface 33 can be pressed down to the same elevation as the front-side finger-slide surface 2. Namely, the fingerprint sensor 1 and the movable rear-side finger-slide surface 33 are in such a state as to bulge relative to the front-side finger-slide surface 2 when a finger slide is not performed (see FIG. 15). The fingerprint sensor 1 and the sensor movement mechanism for moving the fingerprint sensor 1 have the same configuration that moves the fingerprint sensor 1 in the first and second embodiments, and a description thereof will be omitted.

In the configuration noted above, the fingerprint sensor 1 and the movable rear-side finger-slide surface 33 are shifted against the elastic force of the springs 7 and 9 in the direction Z2 in the figure upon being pressed. Upon being released from the pressing, the fingerprint sensor 1 and the movable rear-side finger-slide surface 33 move in the direction Z1 by the elastic restoration force of the springs 7 and 9 to return to their original positions.

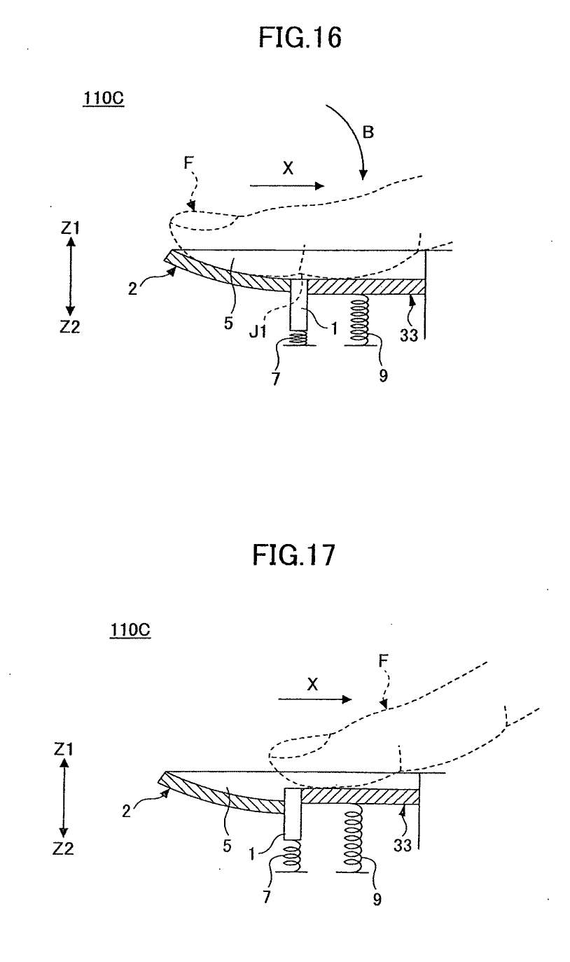

In order to scan the fingerprint FP by use of the fingerprint reader device 110C having the configuration described above, the finger F is slid as illustrated in FIG. 15 over the front-side finger-slide surface 2 in the finger-slide direction (as illustrated by an arrow X in FIG. 16) while stretching the finger F. In so doing, the sense of touch provided by the finger F is also utilized in addition to visual contact. The first joint J1 of the finger F is then brought in contact with the fingerprint sensor 1 bulging from the front-side finger-slide surface 2 while ensuring that the ball of the finger F is evenly in contact with the paired guide sidewalls 4 and 5.

After performing positional adjustment to move the finger F to the correct position, the stretched finger F is tilted to press down the fingerprint sensor 1 and the movable rear-side finger-slide surface 33 (i.e., pressing them down in the direction indicated by an arrow B in FIG. 16). As a result, the fingerprint sensor 1 and the movable rear-side finger-slide surface 33 are pressed down to the same elevation as the front-side finger-slide surface 2 as illustrated in FIG. 16.

In this manner, the first joint J1 can be placed at the center point O of the fingerprint sensor 1. After this, the finger F is slid at constant speed in the direction of the arrow X while pressing down the fingerprint sensor 1 with the ball of the finger F as illustrated in FIG. 17, thereby performing correct scanning of the fingerprint FP. In so doing, the fingerprint sensor 1, the movable rear-side finger-slide surface 33, and the front-side finger-slide surface 2 form a single continuous surface, so that the fingerprint sensor 1 and the movable rear-side finger-slide surface 33 do not obstruct the sliding movement of the finger F.

With this arrangement, it is possible to adjust the position of the first joint J1 to place it at the center point O of the fingerprint sensor 1 even when the fingerprint sensor 1 is obscured behind the finger F. Namely, the finger-slide-surface movement mechanism (i.e., spring 9) and the movable rear-side finger-slide surface 33 as well as the sensor movement mechanism (i.e., spring 7) and the fingerprint sensor 1 serve as a positioning device for positioning the first joint J1 of the finger F at the center point O of the fingerprint sensor 1.

In the present embodiment also, the fingerprint sensor 1 is constantly pressed against the finger F being slid, similarly to that of the first and second embodiments previously described. Accordingly, a correct image can be obtained even in the case of scanning the fingerprint FP of a thin finger or tapering finger or in the case of scanning the fingerprint FP for a child or an elderly person. This can further improve the authentication rate.

The above-described embodiment has been directed to an example in which the fingerprint sensor 1 and the movable rear-side finger-slide surface 33 move independently of each other. Alternatively, the fingerprint sensor 1 and the movable rear-side finger-slide surface 33 may be integrated so as to move together with each other.

Further, the present invention is not limited to these embodiments, but various variations and modifications may be made without departing from the scope of the present invention.

1. A fingerprint reader device, comprising:
a slide-type fingerprint sensor; and
a positioning structure that causes a first joint portion of a finger to be positioned at a center point of the fingerprint sensor,
wherein the positioning structure includes a sensor movement mechanism that keeps the fingerprint sensor at a position bulging from a slide surface on which the finger is slid when the fingerprint sensor is not pressed down, and that allows the fingerprint sensor to move upon being pressed down.

2. A fingerprint reader device, comprising:
a slide-type fingerprint sensor; and
a positioning structure that causes a first joint portion of a finger to be positioned at a center point of the fingerprint sensor,
wherein the positioning structure includes:
a slide surface on which the finger is slid and which includes a front-side finger-slide surface situated anterior to the position of the fingerprint sensor in a finger-slide direction and a rear-side finger-slide surface situated posterior to the position of the fingerprint sensor in the finger-slide direction;
a sensor movement mechanism that keeps the fingerprint sensor at a position bulging from the rear-side finger-slide surface when the fingerprint sensor is not pressed down, and that allows the fingerprint sensor to move upon being pressed down; and
a finger-slide-surface movement mechanism that keeps the front-side finger-slide surface at a position bulging from the rear-side finger-slide surface when the front-side finger-slide surface is. not pressed down, and that allows the front-side finger-slide surface to move upon being pressed down.

3. A fingerprint reader device, comprising:
a slide-type fingerprint sensor; and
a positioning structure that causes a first joint portion of a finger to be positioned at a center point of the fingerprint sensor,
wherein the positioning structure includes:
a slide surface on which the finger is slid and which includes a front-side finger-slide surface situated anterior to the position of the fingerprint sensor in a finger-slide direction and a rear-side finger-slide surface situated posterior to the position of the fingerprint sensor in the finger-slide direction;
a sensor movement mechanism that keeps the fingerprint sensor at a position bulging from the front-side finger-slide surface when the fingerprint sensor is not pressed down, and that allows the fingerprint sensor to move upon being pressed down; and
a finger-slide-surface movement mechanism that keeps the rear-side finger-slide surface at a position bulging from the front-side finger-slide surface when the rear-side finger-slide surface is not pressed down, and that allows the rear-side finger-slide surface to move upon being pressed down.

4. An electronic apparatus, comprising:
a fingerprint reader device; and
a processing unit,
wherein the fingerprint reader device includes:
a slide-type fingerprint sensor; and
a positioning structure that causes a first joint portion of a finger to be positioned at a center point of the fingerprint sensor,
wherein the positioning structure includes a sensor movement mechanism that keeps the fingerprint sensor at a position bulging from a slide surface on which the finger is slid when the fingerprint sensor is not pressed down, and that allows the fingerprint sensor to move upon being pressed down,
and wherein the processing unit processes data scanned by the fingerprint sensor of the fingerprint reader device.

5. An electronic apparatus, comprising:
a fingerprint reader device; and
a processing unit,
wherein the fingerprint reader device includes:
a slide-type fingerprint sensor; and
a positioning structure that causes a first joint portion of a finger to be positioned at a center point of the fingerprint sensor,
wherein the positioning structure includes:
a slide surface on which the finger is slid and which includes a front-side finger-slide surface situated anterior to the position of the fingerprint sensor in a finger-slide direction and a rear-side finger-slide surface situated posterior to the position of the fingerprint sensor in the finger-slide direction;
a sensor movement mechanism that keeps the fingerprint sensor at a position bulging from the rear-side finger-slide surface when the fingerprint sensor is not pressed down, and that allows the fingerprint sensor to move upon being pressed down; and
a finger-slide-surface movement mechanism that keeps the front-side finger-slide surface at a position bulging from the rear-side finger-slide surface when the front-side finger-slide surface is not pressed down, and that allows the front-side finger-slide surface to move upon being pressed down,
wherein the processing unit processes data scanned by the fingerprint sensor of the fingerprint reader device.

6. An electronic apparatus, comprising:
a fingerprint reader device; and
a processing unit,
wherein the fingerprint reader device includes:
a slide-type fingerprint sensor; and
a positioning structure that causes a first joint portion of a finger to be positioned at a center point of the fingerprint sensor,
wherein the positioning structure includes:
a slide surface on which the finger is slid and which includes a front-side finger-slide surface situated anterior to the position of the fingerprint sensor in a finger-slide direction and a rear-side finger-slide surface situated posterior to the position of the fingerprint sensor in the finger-slide direction;
a sensor movement mechanism that keeps the fingerprint sensor at a position bulging from the front-side finger-slide surface when the fingerprint sensor is not pressed down, and that allows the fingerprint sensor to move upon being pressed down; and
a finger-slide-surface movement mechanism that keeps the rear-side finger-slide surface at a position bulging from the front-side finger-slide surface when the rear-side finger-slide surface is not pressed down, and that allows the rear-side finger-slide surface to move upon being pressed down,
wherein the processing unit processes data scanned by the fingerprint sensor of the fingerprint reader device.
